(19) United States
(12) Patent Application Publication
(10) Pub. No.: US 2011/0180077 A1
(43) Pub. Date: Jul. 28, 2011

(54) Device and Methods for Treatment of Temporomandibular Joint (TMJ) Disorder

(76) Inventor: Rene Garcia, Green Valley, AZ (US)

(21) Appl. No.: 12/692,554

(22) Filed: Jan. 22, 2010

(51) Int. Cl. A61C 5/14

(52) U.S. Cl. 128/861

(57) ABSTRACT

The present invention relates to a mouth guard and methods of use to aid in the treatment of bruxism and temporomandibular joint (TMJ) disorder comprising an adjustable molded thermoplastic outer face plate, an inner face plate and irritation spines, the mouth guard containing a section for placement and fitting to a patient's upper and lower dentition, the molded thermoplastic mouth guard including tooth channels that, upon commencing of tooth grinding, initiate mild irritation to the gums or cheeks of a wearer by the irritation spines wherein, the wearer is alerted to the occurrence of tooth grinding, whether the wearer is sleeping or awake, whereupon the wearer ceases the tooth grinding thereby preventing development of temporomandibular joint (TMJ) disorder and tooth wear.

### FIELD OF THE INVENTION

The present invention relates generally to a device that assists in preventing teeth clenching and grinding in sleeping individuals and more specifically, to a device that effectively treats and prevents bruxism.

### BACKGROUND OF THE INVENTION

Bruxism has been defined as excessive grinding or clenching of teeth. The behavioral pattern occurs during sleep or during waking hours and is an involuntary often resulting from stress or habit. Surprisingly, over 80% of individuals with bruxism are completely unaware of the occurrence. As might be expected, bruxism often exerts powerful forces on teeth, gums and joints in the mouth resulting in wearing of the teeth, often over a number of years. Bruxism is often associated with several symptoms and health effects including tooth abrasion, fractures and tooth loss, dental caries, alveolar bone loss, headaches, difficulties in opening the mouth, ear aches and hearing loss, neuralgia, tenderness, pain or fatigue of facial muscles and has been implicated to be the leading cause of several temporomandibular disorders (TMDs)

Presently, several causes are associated to bruxism and vary from patient to patient. Stress, emotions and other psychological factors have been suggested to result in an increase in the frequency of bruxing episodes, although there is no direct evidence that stress itself is a contributing factor to the onset of bruxism. There is also little evidence that a decrease in stress level results in a decrease or cure to bruxism.

Still other evidence has suggested that bruxism may be traceable to drugs or excessive consumption of alcohol. In other cases, bruxism may be associated with malformations in the jaw itself or to abnormal dental occlusion.

Despite extensive study of the condition, an effective treatment for bruxism remains elusive. Over the years, several patents have disclosed devices and methods which seek to provide treatment and prevention of this chronic condition. For example, U.S. Pat. No. 6,302,110 to Yoshida, describes a dental protector for use against bruxism. Specifically, the patent discloses a U-shaped mouth guard adapted to cover the occlusal faces of the teeth and a second part adapted to cover the posterior surfaces of the teeth so to prevent clenching or grinding of the teeth. A unique character of the device is provided by utilizing an occlusal portion which softens at near body temperature thus allowing the device to form fit onto the user's teeth. However, the device fails to provide a device or method that effectively breaks the habit of bruxing and also fails to provide any means by which the individual becomes aware that he is bruxing.

Likewise, U.S. Pat. No. 5,511,562 to Hancock discloses a dental device for treating temporomandibular joint disorders (TSDs). Specifically, the device includes a generally U-shaped mouth guard having an inner and outer side wall with a plurality of connectors positioned between the inner and outer side walls. A pliable material fills the upper and lower compartments of the device so that the grinding or clenching by the patient is prevented and the mandible can be set in a desired position. Like the '110 patent however, the '562 patent fails to provide a method or device that counteracts the chronic condition of bruxism and also fails to communicate when bruxing is taking place, a shortcoming not addressed by the prior art.

U.S. Pat. No. 4,568,280 to Ahlin discloses a craniomandibular appliance comprising a thermoplastic dental arch that is inserted into a patient's mouth. The dental arch is moldable within the mouth to a fixed configuration so that a predetermined mandibular position can be obtained. In order to mold the device, it must be preheated to a temperature above 200° F. by submerging in boiling water. The device however, fails to address the shortcomings of the prior art because it is composed entirely of thermoplastic material so that the entire device becomes malleable when heated, leaving open the possibility that it may harden in an incorrect configuration when removed from the heat if the patient's mandible is not properly positioned.

U.S. Pat. No. 3,924,638 to Mann shows a tension reliever intended to be inserted into a patient's mouth. The device is made of a thermosetting plastic so that it will maintain a rigid form once heated. In a preferred embodiment, the rigid lower surface of the device is lined with softer materials. This softer material, however, is not adapted to form around a user's teeth in such a manner so as to set the mandible in a proper position. Rather, it merely is used to allow the patient to grind his or her teeth without causing any damage to the teeth. Moreover, the device fails to alert the wearer that bruxing is occurring and does not allow the formation of habits tending away from bruxing, either during sleep or waking hours.

Still others have attempted to provide devices and methods to advance development of therapeutic habits through use of biofeedback mechanisms so to alert an effected individual that bruxing is occurring. U.S. Pat. No. 6,164,278 to Nissani for example, discloses a taste-based approach to the prevention of teeth clenching and grinding. Specifically, the mouth piece provides a mildly aversive, safe, liquid that is inserted into and sealed in, small, bilaterally-sleeved, polyethylene capsules. Two capsules are attached to a specially constructed dental device which places the capsules between the lower and upper teeth.

The device and capsules are worn at night or at other times when bruxism is suspected to occur. When bruxing in the individual begins, the capsules rupture and the liquid is released into the mouth which then draws the patient's conscious attention to, and forestalls, any further attempt of teeth clenching or grinding. Although the device and capsules may tend to alert the individual that bruxing is occurring the device fails to address the failings of the prior art in that such capsules must be continually replaced and there remains some question as to whether the capsules are effective in actually awakening a sleeping individual since it is foreseeable that the liquid material may leak from the mouth during sleep. Further, it is difficult to accurately gauge at what pressure the capsules should rupture. For example, it is conceivable that such capsules might rupture prematurely or by mistake during waking hours rendering the device less than effective in minimizing the bruxing habit.

By contrast, the present invention is constructed without the necessity and provision of replacement parts such as the capsules of the '278 patent to fit in the mouth comfortably and providing minor irritation to alert the wearer that bruxing is occurring. It also does not require the consideration of whether capsules are ruptured at the correct time and manner but rather rely on a constant mechanism for alerting the wearer of the occurrence of bruxing, whether during sleep or in waking hours. Moreover, the present invention assists in forming positive habits in preventing bruxism so to prevent the wear of teeth over time and the occurrence of any of several temporomandibular disorders (TMDs).

### SUMMARY OF THE INVENTION

The present invention relates to a dental mouth guard and methods to aid in the treatment of bruxism and temporomandibular joint (TMJ) disorder comprising a molded thermoplastic outer face plate, an inner face plate and irritation spines, the mouth guard containing a section for placement and fitting to an individual's upper and lower dentition, the mouth guard including jaw channels that, upon commencing of tooth grinding, initiate a mild irritation to the gums or inner cheeks of a wearer by the irritation spines wherein, the wearer is alerted to the occurrence of bruxing, whether the wearer is sleeping or awake, whereupon the wearer ceases the tooth grinding thereby preventing development of temporomandibular joint (TMJ) disorder and tooth wear.

### BRIEF DESCRIPTION OF THE DRAWINGS

FIG. 1A depicts a basic configuration of a preferred embodiment of the invention from a front view perspective. In the illustration, the mouth guard of the invention is shown in a non-engaged manner with teeth unclenched. As shown, the flexible tubing of the device or encased within a pliable membrane to keep the tubes in place which rests on teeth of the lower jaw.

FIG. 1B depicts a basic configuration of a preferred embodiment of the invention from a front view perspective. In the illustration, the mouth guard is shown partially engaged by the wearer's teeth, with the teeth partially clenched, such as occurs during bruxing.

FIG. 1C depicts a basic configuration of a preferred embodiment of the invention from a front view perspective. In the illustration, the mouth guard is shown completely engaged by the wearer's teeth, with the teeth fully clenched, such as occurs during bruxing.

FIG. 2 illustrates a side angle perspective of the invention with the outer face plate showing in its entirety. The upper and lower jaw channels are shown without teeth engaged therein.

FIG. 3A depicts an alternative preferred embodiment of the invention from a frontal perspective. Specifically, the mouth guard is shown with teeth placed in the upper and lower jaw channels. Irritation gauge spines are shown non-engaged with the gums of the wearer indicating that no bruxing is occurring in the perspective.

FIG. 3B depicts an alternative preferred embodiment of the invention from a frontal perspective in which irritation gauge spines are shown engaged with the gums of the wearer due to the occurrence of bruxing. The irritation gauge spines contact the gums when the teeth are clenched with the assistance of a pivot point located on the outer face plate.

FIG. 4 illustrates an alternative preferred embodiment of the invention from a side angle perspective. The inner face plate of the invention is shown predominantly.

FIG. 5A illustrates yet another preferred embodiment of the invention from a frontal perspective in which teeth are located in the upper and lower jaw channels. Specifically, the irritation gauge spines are shown non-engaged with the wearer's gums indicating that tooth clenching is not occurring.

FIG. 5B depicts a preferred alternative embodiment of the invention in which the irritation gauge spines are engaged in the gums of the wearer due to the occurrence of bruxing.

FIG. 6 illustrates an alternative preferred embodiment of the invention from a side angle perspective. The irritation gauge spines are shown to fit into spine channels when bruxing occurs.

FIG. 7A depicts a partial perspective of a preferred embodiment of the invention which shows the configuration of the mouth guard when teeth are unclenched.

FIG. 7B depicts a partial perspective of a preferred embodiment of the invention which shows the configuration of the mouth guard when the teeth are clenched.

FIG. 8 depicts a frontal view perspective of a preferred embodiment of the invention. As shown, the illustration provides the configurations of the outer and inner face plates as well as the upper and lower jaw channels.

FIG. 9A illustrates a side view perspective of a preferred embodiment of the invention which shows the device in the mouth of a wearer with teeth unclenched. As shown in dotted lines, the device provides levers for engaging an irritation gauge when teeth are clenched.

FIG. 9B depicts the invention wherein the levers are engaged causing the spines to irritate the gums due to clenching of the teeth.

FIG. 10A illustrates a side view perspective of a preferred embodiment of the invention which shows the device in the mouth of a wearer with teeth unclenched. As shown in dotted lines, the device provides levers for engaging an irritation gauge when teeth are clenched.

FIG. 10B depicts the invention wherein the levers are engaged causing the spines to irritate the gums due to clenching of the teeth.

FIG. 11 depicts a frontal view perspective of a preferred embodiment of the invention. As shown, the illustration provides the configuration of the outer and inner face plates as well as the upper and lower jaw channels.

FIG. 12A illustrates an alternative embodiment of the invention wherein gears are utilized as a means of engaging the irritation spines to the wearer's gums. As shown, the device is shown with teeth unclenched.

FIG. 12B illustrates an alternative embodiment of the invention wherein the teeth are clenched and the spines are engaging the gums of a wearer resulting in minor irritation.

FIG. 13A depicts an alternative embodiment of the invention from a side view perspective. The device is shown with the wearer's teeth in an unclenched position.

FIG. 13B illustrates the device from a side view perspective wherein the teeth of the wearer are clenched as occurs with bruxing.

FIG. 14 depicts a side angle perspective of a preferred embodiment of the invention showing the entirety of the inner face plate. The dotted lines show the flexible tooth grip in a non-engaged configuration.

FIG. 15A shows an alternative preferred embodiment of the invention form a side angle perspective, the embodiment being adjustable by the wearer through use of adjustment pegs and inner face plate.

FIG. 15B shows the adjustable embodiment with the adjustable inner face plate removed to provide illustration of the flexible tooth grip.

FIG. 16A depicts an alternative embodiment of the invention in which the irritation spines are adjustable by the wearer. Specifically, the spines may be removed for smaller sized users as indicated by the dotted line configuration. As shown the figure illustrates the device in a non-engaged manner with teeth unclenched.

FIG. 16B illustrates the alternative embodiment with the teeth clenched on the flexible tooth grip and the irritation spines engaged in the wearer's gum resulting in mild discomfort.

FIG. 17A depicts yet another embodiment of the invention which provides open spaces in both the inner and outer face plates to prevent pooling of saliva in the upper jaw channel. The Figure illustrates the device in a non-engaged manner with teeth unclenched.

FIG. 17B illustrates an embodiment of the invention in which the teeth are engaged on the flexible tooth grip.

FIG. 18 demonstrates the adjustability of this embodiment wherein irritation spines may be removed for use by smaller sized wearers of the device to provide optimum positioning of the device to prevent bruxing.

FIG. 19A depicts yet another alternative embodiment of the invention from a side angle perspective. Specifically, the invention is adjustable with adjustment channels located on the outer face plate and adjustment pegs provided on the inner face plate. In addition, irritation spines are adjustable and may be removed for smaller sized users.

FIG. 19B illustrates an adjustable embodiment of the invention wherein the inner and outer face plates are separated. The perspective provides the mechanism by which a user may remove the inner face plate from the outer face plate to adjust the tooth grip and jaw channel for optimal fit and sizing.

FIG. 20 demonstrates an alternative embodiment of the device wherein a jaw channel extends around the full length of the user's teeth. In this embodiment the device contains irritation spines on both sides of the mouth. During bruxing, the engaging flaps shown push down the spines to mildly irritate the wearer's lower gums.

FIG. 21 illustrates an alternative embodiment of the engaging flaps of the device. During bruxing the engaging flap is flexed resulting in the irritation spines mildly irritating the gums of the user.

FIG. 22A depicts an alternative preferred embodiment of the invention from a frontal perspective. Specifically, the device is provided with a tooth engager on both the upper and lower tooth grips and jaw channels. In this figure, the device is shown while teeth are unclenched.

FIG. 22B illustrates the alternative embodiment of the invention during bruxing or teeth clenching. Specifically, following engaging of the upper and lower tooth engagers a levered mechanism is activated resulting in a mild irritation to the inside of the cheek to alert the wearer that bruxing is occurring.

FIG. 23 illustrates a side angle view perspective of the embodiment wherein the teeth are unclenched.

### DETAILED DESCRIPTION OF THE INVENTION

Current methods of treating teeth grinding, also commonly referred to as bruxing, are significantly lacking Several devices have been designed which purportedly provide effective treatments to assist in preventing an individual from teeth grinding however, all fall short of providing a device and method which assists an individual with development of therapeutic habits, which ultimately lead to a cessation of teeth grinding, a significant risk factor in the onset of temporomandibular joint (TMJ) disorder.

Biofeedback devices are available which alert an individual to the onset of bruxing but the high cost and complexity of such devices puts this type of treatment out of the reach of a large proportion of effected individuals. Moreover, complicated setup of such devices prior to sleep makes compliance with treatment an issue as well. In addition, such devices are designed only to work during sleep and do nothing to address bruxing during waking hours, which often occurs without the knowledge of the individual despite being awake.

Simpler devices have been offered but none address the shortcomings in effectively treating bruxing, namely in alerting the individual that tooth grinding is occurring, nor do they foster development of therapeutic habits which lead to grinding cessation. Devices that are available and designed to alert a bruxing individual to the onset of teeth grinding also suffer from shortcomings which render them less effective than the present invention. U.S. Pat. No. 6,164,278 for example, provides a mouth device in which “taste” and “flavor” capsules are employed which burst at the onset of bruxing in an individual resulting in an unpleasant taste which purportedly alerts the individual that bruxing has occurred. However, there is little evidence to show that the mildly aversive fluid contained in the capsules consistently alerts a sleeping individual that bruxing has commenced. This is especially true in those individuals in which the fluid might leak from the mouth due to sleeping with the mouth open.

Accordingly, the invention relates to a dental device and methods of its use to effectively treat bruxing with the intent of preventing the onset of temporomandibular joint (TMJ) disorder, a disorder associated with the occurrence of chronic teeth grinding. The dental device is composed of a thermoplastic resin and includes irritation gauge spines which are activated whenever bruxing occurs.

Specifically, the present invention relates to a mouth guard and methods of use to aid in the treatment of bruxism and temporomandibular joint (TMJ) disorder comprising an adjustable molded thermoplastic outer face plate, an inner face plate and irritation spines, the mouth guard containing therein a section for placement and fitting to a patient's upper and lower dentition, the molded thermoplastic mouth guard including tooth channels that, upon commencing of tooth grinding, trigger minor irritation to the gums or cheeks of a wearer via the irritation spines wherein, the wearer is alerted to the occurrence of tooth grinding, whether the wearer is sleeping or awake, whereupon the wearer ceases the tooth grinding thereby preventing development of temporomandibular joint (TMJ) disorder and tooth wear.

The term “bruxing” as used herein refers to the occurrence of tooth grinding in an individual. In most cases, the term refers to a chronic occurrence but may also refer to only occasional tooth grinding. The term also refers to the occurrence of teeth grinding during sleep or waking hours and occurs whether the individual is aware of the tooth grinding or is currently unaware that grinding is taking place. Generally, bruxing will be understood to be a factor in the onset of temporomandibular joint (TMJ) disorder.

The term “outer face plate” as used herein refers to section of the invention that faces outward toward the wearer's cheek. The outer face plate of the invention encompasses several embodiments as described herein.

The term “inner face plate” as used herein refers to the section of the invention that faces inward away from the wearer's cheek. The inner face plate of the invention encompasses several embodiments as described herein.

The term “spines” or “irritation spines” as used herein refers to the section of the invention that provides a mild irritation to the gums or cheek of a wearer to alert of the occurrence of bruxing. Generally, any portion of the invention, regardless of configuration, that acts to mildly irritate the gums or cheek of a wearer will be designated as spines.

The term “mildly irritating”, “mild irritation” as used herein refers the minor discomfort to an individual absent breaking of the skin or abrasiveness which results in tearing of the skin or gum tissues.

The present invention generally provides several sections designed to assist an individual in developing therapeutic habits in reducing or eliminating the occurrence of bruxing either during sleep or waking hours. In doing so, the invention provides a thermoplastic dental device molded to fit the upper and lower jaw and teeth of an individual, the outer face plate including a pivoting section containing irritation spines which mildly irritate the gums or inner cheek of a wearer whenever the individual begins to grind his or her teeth. The irritation spines of the invention are engaged to irritate the gums or inner cheek following initiation of bruxing by clenching of the teeth.

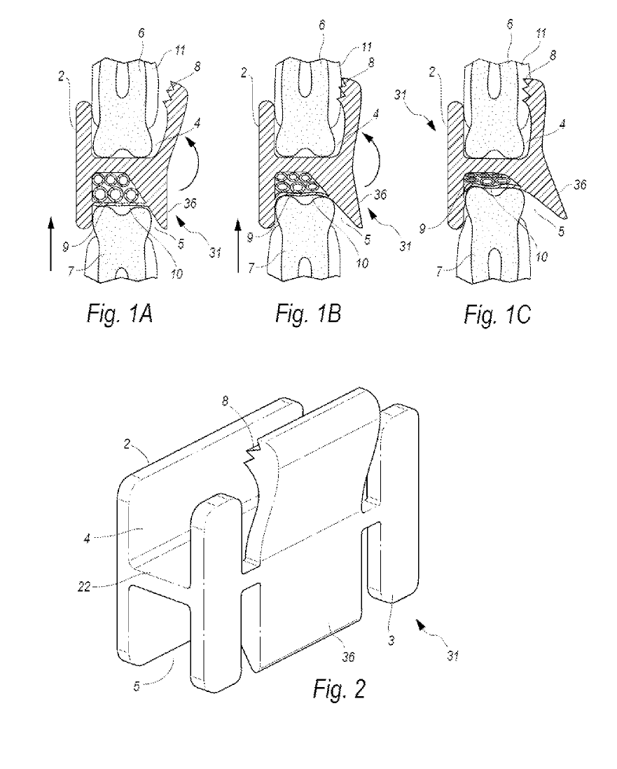

In a preferred embodiment of the invention the dental device fits on either side of the wearer's mouth, the left or right. In the embodiment, several individual flexible tubes are housed within a flexible membrane in a lower jaw channel located between the inner and outer face plates. When clenching of the teeth begins, the teeth apply force on the flexible tubing resulting in a force upon the pivoting section of the outer face plate. (See FIG. 1A, 1B, 1C) Upon clenching of the teeth irritation spines situated at the top of the outer face plate begin to mildly irritate the upper gums of the wearer alerting the individual of the occurrence of bruxing.

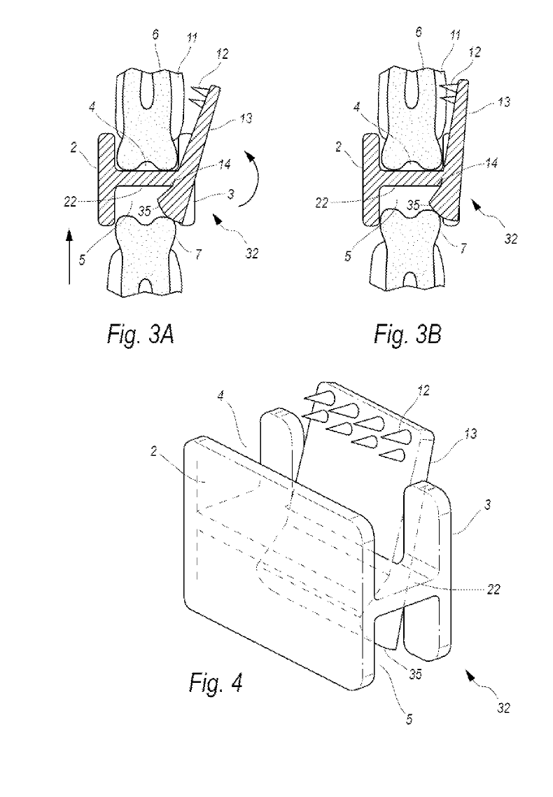

In yet another preferred embodiment, the dental device of the present invention envisions several configurations relating to the irritation spines. For example, the spines may be configured as single or multiple “spear-like” devices, such as shown in FIG. 3A. In a related embodiment a spine channel cross bar 16 and channel pad 17 act to provide a cushion to the spines during periods in which the individual is not clenching teeth, thus preventing irritation of the gums. Likewise, on commencement of bruxing, the spines will move through the spine channel cross bar and channel pad to engage the gums causing mild irritation. (see FIG. 7A, 7B)

In another preferred embodiment of the invention, levers and dental plungers cause spines to mildly irritate the lower gums when clenching begins. As seen in FIG. 9A, 9B, 10A, 10B, upon clenching, the upper plunger 24 pushed downward onto pivoting levers which then push downward on a lower dental plunger that includes irritation spines at the lower end of the plunger, that mildly irritate the gums to alert of the occurrence of bruxing. The levers of the invention which act upon the lower plunger as envisioned herein may be configured in a number of designs and include those not shown but which are nonetheless foreseeable as described herein.

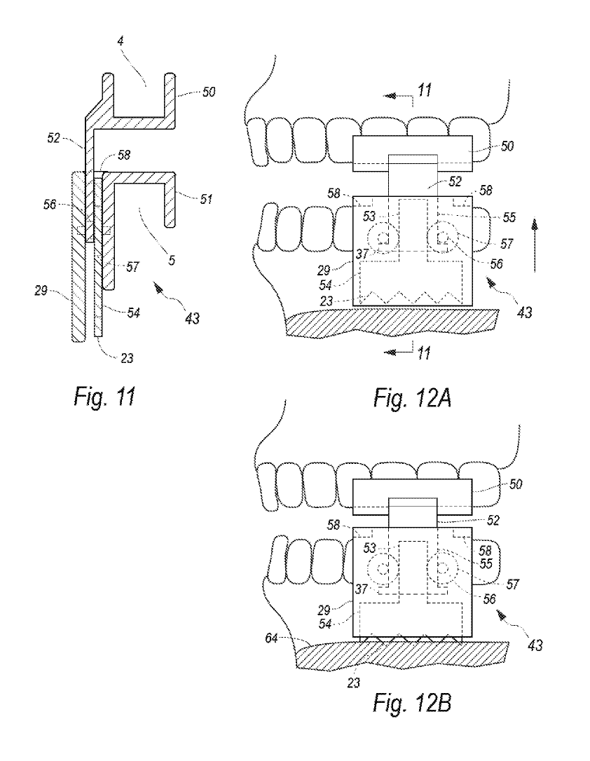

In a related embodiment, the plungers act to irritate the lower gums of an individual via the use of wheeled gears configured between the upper and lower plungers. As shown in FIGS. 12A and B, upon clenching, the upper plunger moves downward engaging a retractable gear mechanism that moves the lower plunger, which has attached to its end, irritation spines, that mildly irritate the lower gums, alerting the wearer as to the onset of bruxing.

In yet another preferred embodiment, the present invention allows a wearer to adjust the size of the dental device so to accommodate individuals of all sizes. Specifically, the inner face plate may be fitted to possess adjustment pegs as shown in FIGS. 15A and B. The device may be shortened to allow smaller individuals to utilize the device more effectively. Further, the ability to adjust the device also allows a user to adjust the sensitivity by which the mild irritation occurs. For example, the device may be adjusted so that only a small degree of bruxing, such as during sleep, results in mild irritation. Alternatively, during waking hours, the device may be adjusted so that a greater degree of tooth clenching is required before mild irritation begins so that the individual can wear the device without the occurrence of constant mild irritation to the gums or cheek.

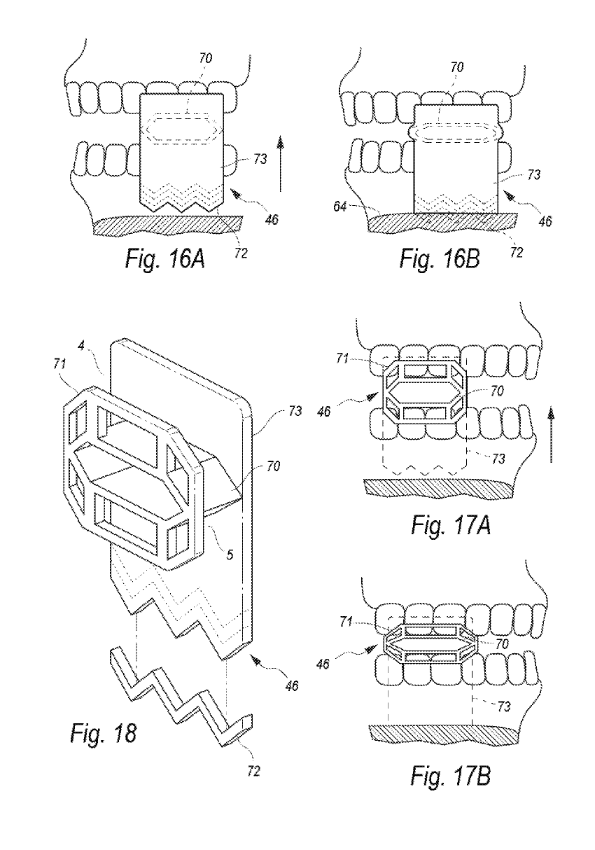

In another preferred embodiment, the irritation spines of the device may likewise be adjusted to accommodate any variety of wearer. As shown in FIG. 16, sections of the spines may be removed to make the lower plunger smaller to better fit in smaller individuals. Similarly to the adjustment pegs, the removable spines allows the wearer to adjust the sensitivity in which mild irritation of the spines occurs. As envisioned by the present invention, a wearer may utilize and adjust one dental device for sleeping in which the sensitivity is adjusted to allow mild irritation on commencement of mild bruxing. Conversely, another device may be utilized and adjusted for day time use to allow irritation to occur only after more significant tooth grinding begins so to allow the wearer to utilize the invention without interfering with speaking.

As encompassed in the present invention, the device may be configured to occupy either side of the mouth or alternatively, may be configured to act as a lower jaw dental device as shown in FIG. 20, wherein engaging flaps 79, 80 result in a downward pressure on irritation spines, when bruxing commences. In this embodiment, irritation spines occupy both sides of the device. Irritation spines can be prepared from various materials as known in the art, including molded thermoplastic resin, appropriate polymers such as Teflon and metal alloys known to be appropriate for dental orthodontics.

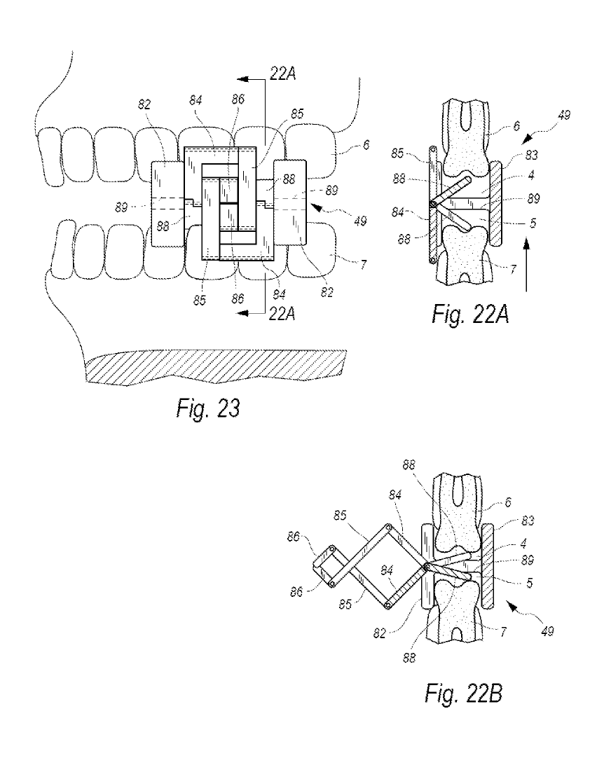

In yet another embodiment, the device is configured with tooth engagers situated inside the upper and lower jaw channels. FIGS. 22A, B and 23 illustrate how the tooth engagers 88 are located when teeth are either clenched or unclenched. On commencement of bruxing, levers are mobilized and result in mild irritation of the inner cheek of the wearer. Levers as encompassed in the present invention may be prepared from materials known in the art such as certain polymers or metal alloys appropriate for dental orthodontics.

To prepare the molded sections of the device, a thermoplastic resin is employed to provide ease of manufacturing and low cost in preparing the device. For manufacturing the upper and lower jaw channels, materials such as those known in the art may be utilized. For example, ethylene-vinyl acetate copolymer is used however, other materials such as polyurethane, silicone resin, poly(vinyl acetate) and other appropriate materials be used likewise. To prepare the irritation spines, a more rigid material such as silicone based polymers or Teflon are utilized in which the material is molded at melting point temperatures and cooled to produce the necessary size of the spines. Levers and the like as described herein are produced by methods known in the art.

Injection molding is accomplished by large machines called injection molding machines. Resin is fed to a machine through what is called a hopper. Colorants are fed to the machine directly after the hopper. The resins enter the injection barrel by gravity though the feed throat. Upon entrance into the barrel, the resin is heated to the appropriate melting temperature.

The resin is injected into the mold by a reciprocating screw or a ram injector. The reciprocating screw offers the advantage of being able to inject a smaller percentage of the total shot (amount of melted resin in the barrel). The ram injector must typically inject at least 20% of the total shot while a screw injector can inject as little as 5% of the total shot.

The mold is the part of the machine that receives the plastic and shapes it appropriately. The mold is cooled constantly to a temperature that allows the resin to solidify and be cool to the touch. The mold plates are held together by hydraulic or mechanical force. The clamping force is defined as the injection pressure multiplied by the total cavity projected area. Typically molds are overdesigned depending on the resin to be used. Each resin has a calculated shrinkage value associated with in.

Although the description for manufacturing the present invention is provided, such description is not limiting and other methods as known in the art will be understood as being encompassed within the scope of the present invention.

Reference is now made to FIGS. 1-23, which illustrate various embodiments of the invention.

FIGS. 1A, 1B and 1C show a front view perspective of a preferred embodiment of the invention 31. Specifically, the inner face plate 2 forms the inner portion and is bridged to the pivoting outer face plate 36 by upper 4 and lower jaw channels 5 and a connecting cross bar 22. As shown, the pivoting outer face plate is activated by tooth grinding when teeth 6, 7 apply pressure to a soft membrane 10 and individual flexible tubing 9 which apply upward pressure against the pivoting outer face plate. In doing so, the top of the pivoting outer face plate has fixed on it a set of spines 8, known as irritation gauge spines or simply irritation spines, which mildly irritate the upper gums 11 of the individual as to the onset of bruxing.

FIG. 1A shows the device during times of non-clenching of the teeth. FIG. 1B shows the device during moderate bruxing. FIG. 1C shows the device when fully engaged and mildly irritating the gums of a wearing following onset of bruxing

FIG. 2 illustrates a side view perspective of a preferred embodiment of the invention. Specifically, the Figure shows the predominating features of the embodiment including the connecting cross-bar 22, the upper 4 and lower jaw channels 5, the inner 2 and outer face 3 plates, the pivoting outer face plate 36 and the irritation spines 8 and how they are configured in the embodiment.

FIGS. 3A and 3B illustrate a related embodiment to that previously described. Specifically, the dental device is shown with an alternative design for the irritation spines in which the spines are made up of an individual or multiple spines 12 that mildly irritate the gums 11 of the wearer during the onset of bruxing. In the embodiment the outer face plate is comprised of a pivot point 35 which deflects the irritation spines toward the gums in order to apply mild irritation thereon to alert the wearer of tooth grinding. FIG. 3A shows the device during times of non-clenching of the teeth. FIG. 3B shows the device when fully engaged and mildly irritating the gums of a wearing following onset of bruxing.

FIG. 4 is a side view perspective of the related preferred embodiment and illustrates the majority of the predominating portions of the embodiment. Specifically, the view shows the inner face plate predominantly with cross-hatching shown to illustrate the cross-bar and upper and lower jaw channels. The pivot point 35 of the outer face plate is also shown.

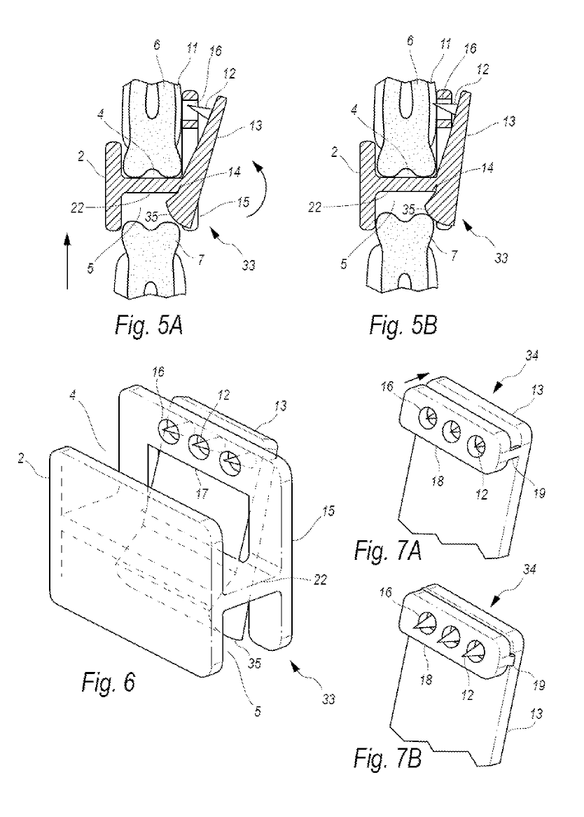

FIGS. 5A and 5B provide a front view perspective of a preferred alternative embodiment of the invention in which a spine channel 16 is used, the spine channel being designed to provide a barrier between the irritation spines and the wearer's gums during times of non-bruxing. FIG. 5A provides the device during non-clenching of the teeth, while FIG. 5B shows the device during tooth grinding.

FIG. 6 shows the related embodiment from a side angle perspective. Specifically, the spine channels 16 are situated in the upper portion of the outer face plate 15 and run along the length of a spine channel cross-bar 17.

FIGS. 7A and 7B provide a detailed view of the spine channels 16 and spines 12. Specifically, a flexible connection 19 is located between the outer face plate 13 and the spine channel pad 18, which contains the spine channels. FIG. 7A shows the dental device when teeth are unclenched, while FIG. 7B shows the device when the teeth are clenched and the spines are mildly irritating the upper gums of a wearer. On clenching, the spine channel pad compacts under the force of the clenching, allowing greater extension of the spines into the gum area.

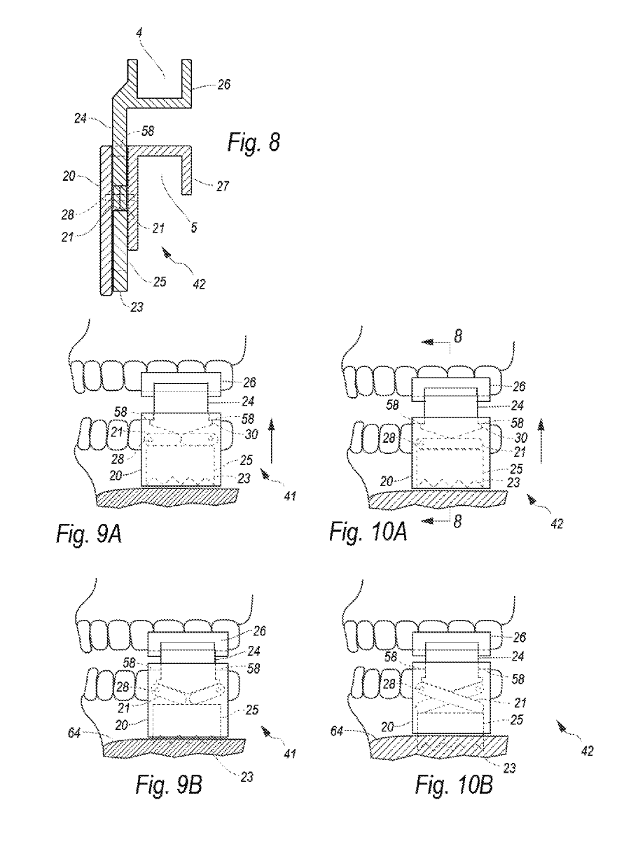

FIG. 8 provides a detailed configuration of an alternative embodiment of the invention 42, in which the irritation spines extend downward to mildly irritate the lower gums of a wearer subsequent to the onset of bruxing. Specifically, an upper jaw piece 26 is shown to form a portion of the inner face plate 27 and upper 4 and lower 5 jaw channels. The outer face plate 20 is situated adjacent an upper plunger 24 which contains at its lower end, a set of irritation spines or irritation teeth, the lower portion of the plunger 25 containing the spines.

A connecting cross-bar 58 is shown which connects the inner face plate to the outer via a lever 21, the outer lever being engaged to an axle that controls the movement of the plunger in either an upward or downward direction. In a non-clenched position, the axle applies upward pressure on the plunger so that the plunger moves upward and thus, does not irritate the lower gums. Upon onset of bruxing the teeth apply downward pressure on the lower plunger and the irritation spines mildly irritate the gums.

FIGS. 9A and 9B show a side view perspective of a preferred embodiment of the invention 41 which utilizes irritation spines to mildly irritate the lower gums and mouth 64. Specifically, FIG. 9A shows the dental device when teeth are unclenched wherein the upper jaw piece 26 accommodates the upper jaw. In the illustration, the levers 21 are shown in hatched cross section, maintained in place by single axles 28. In a non-clenched position, the plunger for the upper jaw 24 is maintained in position by a small connecting cross-bar 58 and retention lip 30. The lower jaw plunger 25 containing the irritation spines 23 is also provided.

FIG. 9B shows the dental device when clenched between teeth of a wearer. Specifically, the illustration shows movement of the levers 21 when downward pressure is applied to the upper and lower plungers 24, 25 respectively. Upon onset of bruxing, the irritation spines engage and mild irritate the lower gum and mouth, alerting the individual as to bruxing, whether the individual is sleeping or awake.

FIGS. 10A and 10B provide illustration of a modified embodiment of the invention 42. Specifically FIG. 10A illustrates the dental device in an unclenched position, and 10B in a clenched position. Similar to as previously described, the embodiment utilizes a lever 21 configured in place with an axle 28 which allow movement of the upper 24 and lower 25 plungers to move up and down depending on pressure exerted thereon. The upper jaw is accommodated in an upper jaw channel and jaw piece 26 and lower jaw in a lower jaw channel and jaw piece 27.

FIG. 10B is also illustrated. In this illustration, the teeth are shown during clenching with the irritation spines irritating the lower gums and mouth 64 of the wearer, alerting the individual to the onset of bruxing.

FIG. 11 provides an alternative preferred embodiment of the invention 43 in which a wheeled gear is provided to allow upward and downward movement of the upper and lower plungers, and thus, the irritation spines, to move to either engage or not engage mild irritation of the lower gums and mouth. Specifically, the device is comprised of upper and lower inner face plate portions 50, 51, respectively, which form an adjacent side of the upper 4 and lower 5 jaw channels.

Also provided in FIG. 11, is an outer face plate 29 which sits adjacent to an upper plunger section 52, the upper plunger section being situated above a smaller sized wheel gear 56, with a connecting cross bar 58 placed between the outer and inner face plates. When engaged by the downward pressure coming from the upper plunger, the plunger exerts pressure on the smaller sized gear 56 which in turn engages an adjacently situated larger wheel gear 57. A lower plunger section 54 has at its end attached irritation spines 23 which mildly irritate the lower gums and mouth of the wearer following onset of the bruxing.

FIGS. 12A and 12B provide an illustration of a side view perspective of the alternative embodiment of the dental device. Specifically, upper jaw channel 50 is shown which accommodates the upper jaw and is attached to an upper plunger 52 which contains gear teeth 53, 55 that directly engage the wheeled gears 56, 57, respectively. The lower plunger 54 is shown which has attached at its lower section, irritation spines 23 that engage and mildly irritate the lower gums and mouth of a wearer. A connecting cross bar 58 and retention lip 37 act to keep the upper and lower plungers in place when teeth are not clenched. FIG. 12A illustrates the device as it is configured when teeth are not clenched. FIG. 12B shows the device when teeth are clenched and the irritation spines are mildly irritating the lower gums.

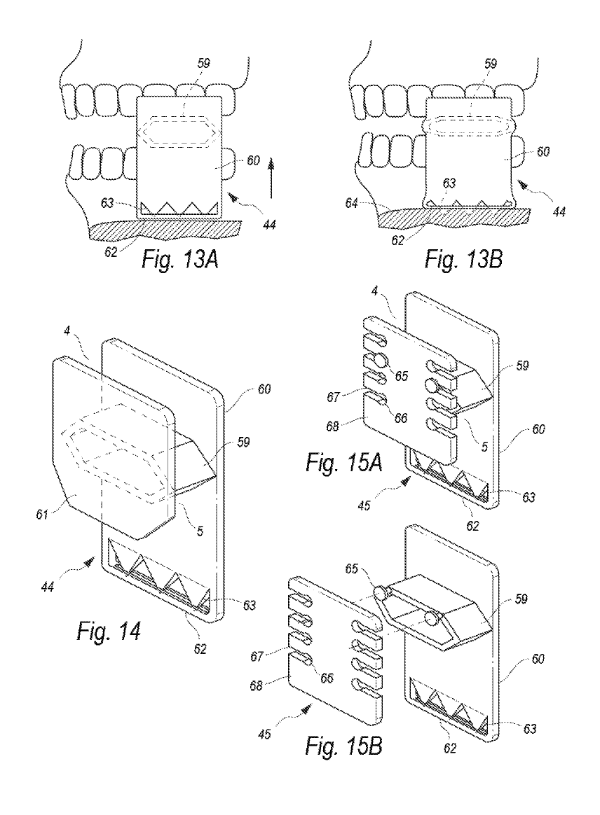

FIGS. 13A and 13B illustrate an alternative embodiment of the present invention 44 which utilizes a flexible resin casing 59 to form a portion of the upper and lower jaw channels. The outer face plate 60 is shown with irritation spines 63 shown just above the lower gums and mouth. FIG. 13A illustrates the device when teeth are unclenched. FIG. 13B illustrates the embodiment wherein the teeth are clenched and the spines are mildly irritating the lower gums of an individual. Further provided in the illustrations is a spine guard 62 designed to limit the amount of length of the spines that irritate the gums and lower mouth.

FIG. 14 illustrates a side view perspective of the above described embodiment 44 which includes upper and lower jaw channels 4, 5 respectively, and outer 60 and inner 61 face plates. The irritation spines 63 are provided as well as the spine guard 62.

FIGS. 15A and 15B illustrate a related embodiment 45 of the invention in which the inner face plate is adjustable in order to accommodate a variety of sizes and in order to provide a wearer the ability to adjust the sensitivity in which mild irritation begins upon onset of bruxing. Specifically, FIG. 15A shows the inner face plate placed onto the flexible casing 59, which make up the upper 4 and lower 5 jaw channels. Adjustment pegs 65 attached to the flexible casing latch onto adjustment slots 67 located on the inner face plate 68 and fit into adjustment holes located thereon 66. The irritation spines are also provided 63 with a flexible tooth guard 62 to prevent excessive irritation.

FIG. 15B illustrates how the dental device may be adjusted. To adjust the device, the inner face plate 68 is removed and placed into a position on the adjustment pegs 65 which provides the optimal fit and level of sensitivity with regard to the individual wearer.

FIGS. 16A and 16B illustrate a related embodiment 46 to that previously described. Specifically, the illustration provides a device in which the irritation spines for the lower portion of the outer face plate 73 and are adjustable 72 in order to accommodate different sizes in individuals. The ability to adjust the spines also allows the wearer to adjust the level of sensitivity of the device.

For example, the spines of the device may be shortened so that during waking hours, the spines are require more tooth grinding before irritation begins. This ability allows the wearer to live a more normal daily life while keeping the device in place and preventing bruxing. Likewise, a second device may be adjusted to keep spines long so that a lower degree of bruxing is required for mild irritation to begin. This allows the user to be alerted to the onset of bruxing promptly and develop habits that will establish healthy sleeping.

FIG. 16B illustrates the device during tooth grinding. Pressure from grinding applies pressure to the flexible casing 70 resulting in downward pressure on the outer face plate 73 and thus, the irritation spines 72 create a mild irritation on the lower gums and mouth 64. FIG. 16A illustrates the device wherein teeth are unclenched.

FIGS. 17A and 17B illustrate a related preferred embodiment of the invention 46. Specifically, the embodiment provides an inner face plate 71 that is vented in order to prevent excessive pooling of saliva in the mouth of the wearer. As shown, FIG. 17A shows the device when teeth are unclenched and spines 73 are not irritating the wearer. FIG. 17B provides an illustration of the device in which the flexible casing 70 is compressed and the teeth are clenched.

FIG. 18 provides a side angle view perspective of a preferred embodiment of the invention 46. The illustration provides a perspective in which the irritation spines 72 are shown to be removable in order to optimize the fit and level of sensitivity of irritation in different individuals.

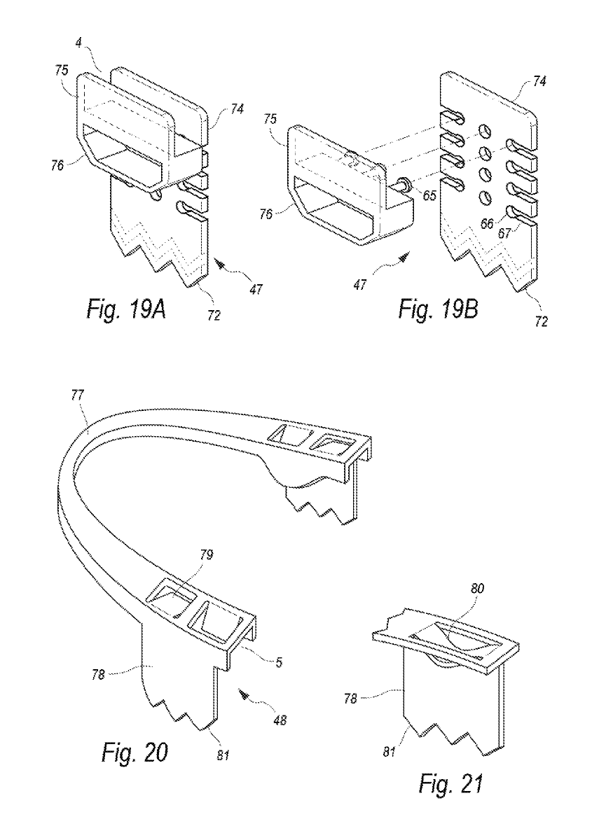

FIGS. 19A and 19B provide an alternative preferred embodiment of the invention 47. Specifically, the inner face plate 75 of the embodiment forms a portion of the flexible casing 76 and is adjustable with the use of adjustment pegs 65 which fit into adjustment slots 67 and holes 66 located on the outer face plate 74. As previously described, the irritation spines 72 shown are adjustable to accommodate different sized wearers and optimize fit and sensitivity of the device. FIG. 19B illustrates how the inner face plate 75 and flexible casing 76 can be separated from the outer face plate 74 to adjust size.

FIG. 20 illustrates yet another preferred embodiment of the invention 48. Specifically, the device is one which provides a lower jaw channel 5 and jaw seat 77 and which fits over the lower teeth. The embodiment further provides engaging flaps 79 that act to apply downward pressure on the outer face plate 78 resulting in downward pressure on the lower gums and mouth of a wearer by irritation spines 81 located at the lower section of the outer face plate, following the onset of tooth grinding. FIG. 21 provides an alternative design of the engaging flaps 80 which apply downward pressure on the outer face plate following onset of bruxing.

FIGS. 22A and 22B provide a front view perspective of yet another preferred embodiment of the invention 49 in which the inner cheek of a wearer is mildly irritated following initiation of tooth grinding. As previously described, the device includes an upper 4 and lower 5 jaw channel and a connecting cross bar 89, as well as inner 83 and outer 82 face plates. FIG. 22A illustrates the device prior to tooth grinding with upper 6 and lower 7 teeth applying no pressure on tooth engagers 88 which are situated between the teeth and the connecting cross bar 89. FIG. 22B illustrates the device following onset of bruxing. Specifically, the upper 6 and lower 7 teeth apply pressure on tooth engagers 88 resulting in flexing of several levers 84, 85. At the tip of the levers an irritation spine 86 mildly irritates the inner cheek of the wearer alerting the individual as to the onset of bruxing. FIG. 23 provides a side perspective of the embodiment of the invention 49.

Certain advantages can be obtained in utilizing the present invention to treat bruxism and in preventing the onset of temporomandibular joint (TMJ) disorder. Foremost, the simplicity of the mouth guard in manufacturing results in significant savings to the consumer maximizing the market potential for the device. The present invention is also effective because it produces a minor irritation to the user without the need to replace the so-called “flavor” capsules offered by other devices. Moreover, the invention bypasses the significantly expensive biofeedback devices that require electronic monitoring and electric impulses to alert the wearer of the onset of bruxing. Such devices, due to their high cost, are out of the reach of a significant portion of the market requiring treatment for bruxing and prevention of TMJ.

Further, the device of the present invention provides a mouth guard that is adjustable by the wearer so to accommodate smaller individuals if necessary. Because the outer and inner face plates of the device may also be adjusted, the invention provides a mouth guard to treat bruxing in the entire population of individuals requiring such treatment. The long term benefits of using the device are significant as well. Tooth wear over the course of one's lifetime results in tooth loss later in life and other disorders related to the mouth which adversely affect the lifestyle of the individual. Significant cost savings are also realized in that a wearer of the invention may forego the expense of adult orthodontics surgery or other treatments.

In realizing yet another advantage, the present invention will provide patients with an effective option in the treatment for bruxing, thus, addressing a critical unmet need. Further, the invention fosters formation and development of positive therapeutic habits by alerting the wearer that bruxing is occurring, whether the individual is sleeping or awake. Over an extended period of use, the wearer forms habits which avoid bruxing. Eventually, such habits diminish the need for any treatment and the individual is then able to live free of the debilitating effects of TMJ.

The present invention is also easily adapted to operate and fit into any individual because it is easily adjusted. It can also be worn in waking hours or during sleep so that the individual is alerted to the onset of bruxing anytime of the day or night.

Although the invention has been described with reference to the above examples, it will be understood that modifications and variations are encompassed within the spirit and scope of the invention. Accordingly, the invention is limited only by the following claims.

What is claimed is:

1. A dental mouth guard to aid in the treatment of bruxism and temporomandibular joint (TMJ) disorder comprising a molded thermoplastic outer face plate, an inner face plate and irritation spines, the mouth guard containing a section for placement and fitting to an individual's upper and lower dentition, the mouth guard including jaw channels that, upon commencing of tooth grinding, initiate a mild irritation to the gums or inner cheeks of a wearer by the irritation spines wherein, the wearer is alerted to the occurrence of bruxing, whether the wearer is sleeping or awake, whereupon the wearer ceases the tooth grinding thereby preventing development of temporomandibular joint (TMJ) disorder and tooth wear.

2. The mouth guard of claim 1, further comprising irritation spines that are adjustable so to fit wearers of various sizes.

3. The mouth guard of claim 2, further comprising irritation spines that mildly irritate only the lower gums when teeth are clenched.

4. The mouth guard of claim 2, further comprising irritation spines that mildly irritate only the upper gums when teeth are clenched.

5. The mouth guard of claim 1, further comprising levers that cause the irritation spines to begin mild irritation of the gums of a wearer when teeth are clenched.

6. The mouth guard of claim 1, further comprising wheeled gears that engage the irritation spines resulting in mild irritation to the gums of a wearer when teeth are clenched.

7. The mouth guard of claim 2, further comprising upper and lower jaw channels that are adjustable to fit wearers of various size by use of several adjustment pegs, essentially as shown in FIG. 15 or 19.

8. The mouth guard of claim 1, wherein the mouth guard occupies only one side of the mouth.

9. The mouth guard of claim 1, wherein the mouth guard occupies the entire lower jaw.

10. The mouth guard according to claim 1 essentially as shown in FIG. 2, 4, 6, 9, 12, 14, 15, 18, 19, 20 or 22.

11. A method of treating temporomandibular joint disorder (TMJ) and bruxism comprising placement in the mouth of an effected individual with a dental mouth guard that produces a mild irritation of the gums or cheeks through one or more irritation spines when tooth grinding occurs, the mouth guard comprising inner and outer face plates and irritation spines and a section for placement and fitting to a patient's upper and lower dentition, the mouth guard including jaw channels for placement of the upper and lower jaw wherein, the wearer is alerted to the occurrence of tooth grinding, whether the wearer is sleeping or awake, whereupon the wearer ceases the tooth grinding thereby preventing development of temporomandibular joint (TMJ) disorder and tooth wear.

12. The method of claim 11 further comprising irritation spines that are adjustable to fit wearers of various sizes.

13. The method of claim 11 further comprising irritation spines that engage only the lower gums when teeth are clenched.

14. The method of claim 11 further comprising irritation spines that engage only the upper gums when teeth are clenched.

15. The method of claim 11 further comprising levers that engage the irritation spines resulting in mild irritation to the gums or inner cheeks of a wearer when teeth are clenched.

16. The method of claim 11 further comprising wheeled gears that engage the irritation spines resulting in mild irritation to the gums or inner cheeks of a wearer when teeth are clenched.

17. The method of claim 11 further comprising upper and lower tooth channels that are adjustable to fit wearers of various size via use of several adjustment pegs.

18. The method of claim 11 wherein the mouth guard is occupies only one side of the mouth.

19. The method of claim 11 wherein the mouth guard occupies the entire lower jaw.
